(19) United States
(12) Patent Application Publication
(10) Pub. No.: US 2026/0249782 A1
(43) Pub. Date: Aug. 27, 2026

(54) VEHICULAR INTERIOR REARVIEW MIRROR ASSEMBLY WITH ELECTRIFICATION OF ELECTROCHROMIC ELEMENT

(71) Applicant: Magna Mirrors of America, Inc., Holland, MI (US)

(72) Inventors: J.R. Scott Mitchell, Newmarket (CA); Jonathan Wigger, Holland, MI (US); Traian Miu, Oakville (CA); Gabriele W. Sabatini, Keswick (CA); Marshall A. Zerbe, Hastings, MI (US); Alexander J. Reau, Wyoming, MI (US)

(21) Appl. No.: 19/546,876

(22) Filed: Feb. 23, 2026

Related U.S. Application Data
(60) Provisional application No. 63/762,758, filed on Feb. 25, 2025.

(51) Int. Cl. B60R 1/08; B60R 1/04

(52) U.S. Cl. CPC B60R 1/088; B60R 1/04

(57) ABSTRACT

A vehicular interior electrochromic rearview mirror assembly includes a mirror head adjustable relative to a mounting base and accommodating an electrochromic mirror reflective element. The mirror reflective element includes a front glass substrate, a rear glass substrate, and an electrochromic medium disposed in an interpane cavity between the front glass substrate and the rear glass substrate. The perimeter seal includes one of a laser-welded glass spacer and a laser-welded metallic spacer that is disposed between the front glass substrate and the rear glass substrate and that spaces the front glass substrate and the rear glass substrate.

### CROSS REFERENCE TO RELATED APPLICATION

The present application claims the filing benefits of U.S. provisional application Ser. No. 63/762,758, filed Feb. 25, 2025, which is hereby incorporated herein by reference in its entirety.

### FIELD OF THE INVENTION

The present invention relates generally to the field of interior rearview mirror assemblies for vehicles.

### BACKGROUND OF THE INVENTION

It is known to provide a mirror assembly that is adjustably mounted to an interior portion of a vehicle, such as via a single ball pivot or joint mounting configuration or double ball pivot or joint mounting configuration where the mirror casing and reflective element are adjusted relative to the interior portion of a vehicle by pivotal movement about the single or double ball pivot configuration. The mirror reflective element may comprise an electrochromic mirror reflective element comprising a front glass substrate and a rear glass substrate with an electrochromic medium sandwiched between the glass substrates and bounded by a perimeter seal.

### SUMMARY OF THE INVENTION

An interior rearview mirror assembly includes a mirror head adjustable relative to a mounting base. The mounting base is configured to mount the vehicular interior electrochromic rearview mirror assembly at an interior portion of an interior cabin of a vehicle. The mirror head accommodates an electrochromic mirror reflective element. With the vehicular interior electrochromic rearview mirror assembly mounted at the interior portion of the interior cabin of the vehicle, the mirror head is adjustable by a driver of the vehicle to set a rearward view for the driver. The electrochromic mirror reflective element includes (i) a front glass substrate having a first side and a second side separated from the first side by a thickness of the front glass substrate and (ii) a rear glass substrate having a third side and a fourth side separated from the third side by a thickness of the rear glass substrate. The front glass substrate has an outer peripheral edge that spans between the first side and the second side. The rear glass substrate has an outer peripheral edge that spans between the third side and the fourth side. The electrochromic mirror reflective element includes an electrochromic medium disposed in an interpane cavity of the electrochromic mirror reflective element between the second side of the front glass substrate and the third side of the rear glass substrate. The front glass substrate is joined with the rear glass substrate via a perimeter seal that bounds the electrochromic medium disposed in the interpane cavity. The perimeter seal may include one of (i) a glass spacer disposed between the front glass substrate and the rear glass substrate and (ii) a metallic spacer disposed between the front glass substrate and the rear glass substrate. A transparent electrically conductive coating is disposed at the second side of the front glass substrate and contacts the electrochromic medium. An electrically conductive coating is disposed at the third side of the rear glass substrate. The electrochromic medium is in electrically conductive contact with the transparent electrically conductive coating disposed at the second side of the front glass substrate and with the electrically conductive coating disposed at the third side of the rear glass substrate. The transparent electrically conductive coating is electrically connected to a first electrical connector at the fourth side of the rear glass substrate. The electrically conductive coating is electrically connected to a second electrical connector at the fourth side of the rear glass substrate.

These and other objects, advantages, purposes and features of the present invention will become apparent upon review of the following specification in conjunction with the drawings.

### BRIEF DESCRIPTION OF THE DRAWINGS

FIG. 1 is a perspective view of an interior rearview mirror assembly;

FIG. 2 is a sectional view of the mirror reflective element of the interior rearview mirror assembly of FIG. 1;

FIG. 3 is a sectional view of the mirror reflective element, with a front glass substrate and a rear glass substrate of the mirror reflective element welded together;

FIG. 4 shows the front glass substrate and the rear glass substrate welded to a glass spacer disposed between the front glass substrate and the rear glass substrate;

FIG. 5 shows the front glass substrate and the rear glass substrate welded to a metallic spacer disposed between the front glass substrate and the rear glass substrate;

FIG. 6 shows steps of a laser etching process of forming glass substrates of the mirror reflective element;

FIG. 7 shows steps of forming a recess at an inner surface of the mirror reflective element;

FIG. 8 is a sectional view of the mirror reflective element with electrification of the electrochromic mirror reflective element accomplished via conductive epoxy extending between electrical connecting tabs at the rear surface of the rear glass substrate and conductive layers of the mirror reflective element and along an outer peripheral edge of the rear glass substrate and a perimeter seal of the mirror reflective element;

FIG. 9 is a sectional view of the mirror reflective element with electrification of the electrochromic mirror reflective element accomplished via conductive epoxy extending between the electrical connecting tabs and the conductive layers of the mirror reflective element along the outer peripheral edge of the rear glass substrate and the glass spacer;

FIG. 10 is a sectional view of the mirror reflective element with electrification of the electrochromic mirror reflective element accomplished via through glass vias (TGVs) extending between the electrical connecting tabs and the conductive layers of the mirror reflective element and formed through the rear glass substrate and/or the glass spacer;

FIG. 11 is a sectional view of the mirror reflective element with electrification of the electrochromic mirror reflective element accomplished via conductive epoxy extending along the outer peripheral edge of the rear glass substrate between the electrical connecting tabs and the metallic spacer electrically connected to the conductive layers of the mirror reflective element;

FIG. 12 is a sectional view of the mirror reflective element with electrification of the electrochromic mirror reflective element accomplished via conductive epoxy extending along the outer peripheral edge of the rear glass substrate between the electrical connecting tabs and the metallic spacer electrically connected to the conductive layers of the mirror reflective element, with the metallic spacer electrically insulated from the electrochromic medium;

FIG. 13 is a sectional view of the mirror reflective element with electrification of the electrochromic mirror reflective element accomplished via TGVs formed through the rear glass substrate and extending between the electrical connecting tabs and the metallic spacer electrically connected to the conductive layers of the mirror reflective element, with the metallic spacer electrically insulated from the electrochromic medium; and

FIG. 14 is a sectional view of the mirror reflective element with electrification of the electrochromic mirror reflective element accomplished via TGVs formed through the rear glass substrate and extending between the electrical connecting tabs and the metallic spacer electrically connected to the conductive layers of the mirror reflective element, with the metallic spacer not electrically insulated from the electrochromic medium.

### DESCRIPTION OF THE PREFERRED EMBODIMENTS

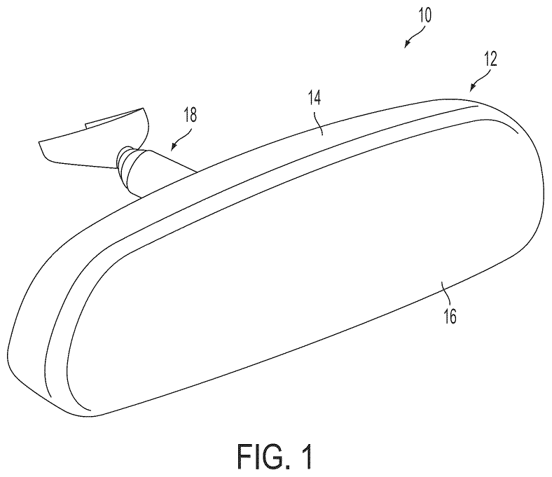

Referring now to the drawings and the illustrative embodiments depicted therein, an interior rearview mirror assembly 10 for a vehicle includes a mirror head 12 that includes a casing 14 and a reflective element 16 positioned at a front portion of the casing 14 (FIG. 1). In the illustrated embodiment, the mirror assembly 10 is configured to be adjustably mounted to an interior portion of a vehicle (such as to an interior or in-cabin surface of a vehicle windshield or a headliner of a vehicle or the like) via a mounting structure or mounting configuration or assembly 18. The mirror reflective element includes a variable reflectance mirror reflective element that varies its reflectance responsive to electrical current applied to conductive coatings or layers of the reflective element.

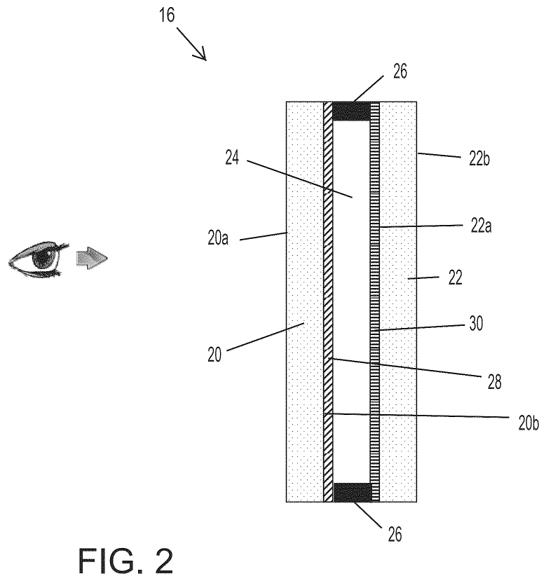

In the illustrated embodiment, and as shown in FIG. 2, the mirror reflective element 16 comprises a laminate construction variable reflectance electro-optic (such as electrochromic) reflective element assembly having a front substrate 20 and a rear substrate 22 with an electro-optic medium 24 (such as electrochromic medium) sandwiched therebetween and bounded by a perimeter seal 26. As shown in FIG. 2, the front substrate 20 has a front or first surface 20a (the surface that generally faces the driver of a vehicle when the mirror assembly is normally mounted at the vehicle) and a rear or second surface 20b opposite the front surface 20a, and the rear substrate 22 has a front or third surface 22a and a rear or fourth surface 22b opposite the front surface 22a, with the electro-optic medium 24 disposed between the second surface 20b and the third surface 22a and bounded by the perimeter seal 26 of the reflective element (such as is known in the electrochromic mirror art). The second surface 20b of the front glass substrate 20 has a transparent conductive coating 28 established thereat (such as an indium tin oxide (ITO) layer, or a doped tin oxide layer or any other transparent electrically semi-conductive layer or coating or the like (such as indium cerium oxide (ICO), indium tungsten oxide (IWO), or indium oxide (IO) layers or the like or a zinc oxide layer or coating, or a zinc oxide coating or the like doped with aluminum or other metallic materials, such as silver or gold or the like, or other oxides doped with a suitable metallic material or the like, or such as disclosed in U.S. Pat. No. 7,274,501, which is hereby incorporated herein by reference in its entirety), while the third surface 22a of the rear glass substrate 22 has a metallic reflector coating 30 (or multiple layers or coatings) established thereat. The front or third surface 22a of the rear substrate 22 may include one or more transparent semi-conductive layers (such as an ITO layer or the like), and one or more metallic electrically conductive layers (such as a layer of silver, aluminum, chromium or the like or an alloy thereof), and may include multiple layers such as disclosed in U.S. Pat. Nos. 7,274,501; 7,184,190 and/or 7,255,451, which are hereby incorporated herein by reference in their entireties. The mirror reflector may comprise any suitable coatings or layers, such as a transflective coating or layer, such as described in U.S. Pat. Nos. 7,626,749; 7,274,501; 7,255,451; 7,195,381; 7,184,190; 6,690,268; 5,140,455; 5,151,816; 6,178,034; 6,154,306; 6,002,511; 5,567,360; 5,525,264; 5,610,756; 5,406,414; 5,253,109; 5,076,673; 5,073,012; 5,115,346; 5,724,187; 5,668,663; 5,910,854; 5,142,407 and/or 4,712,879, which are hereby incorporated herein by reference in their entireties, disposed at the front surface of the rear substrate (commonly referred to as the third surface of the reflective element) and opposing the electro-optic medium, such as an electrochromic medium disposed between the front and rear substrates and bounded by the perimeter seal (but optionally, the mirror reflector could be disposed at the rear surface of the rear substrate (commonly referred to as the fourth surface of the reflective element).

The third surface 22a defines the active EC area or surface of the rear substrate within the perimeter seal 26. The coated third surface 22a may also be coated to define a tab-out region (such as by utilizing aspects of the mirror assemblies described in U.S. Pat. Nos. 7,274,501; 7,184,190 and/or 7,255,451, which are hereby incorporated herein by reference in their entireties) for providing electrical connection of the conductive layers to an electrical clip of connector or bus-bar, such as the types described in U.S. Pat. Nos. 5,066,112 and 6,449,082, which are hereby incorporated herein by reference in their entireties.

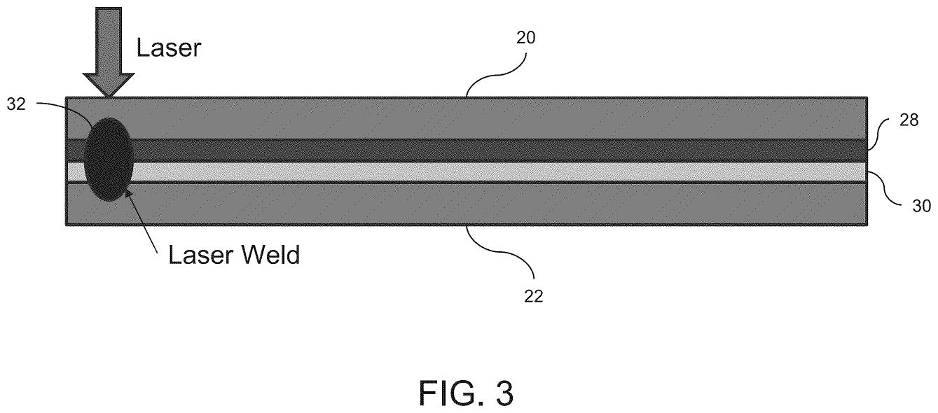

Referring to FIGS. 3-5, the perimeter seal 26 may be formed via a weld 32 (e.g., a laser weld) between the front substrate 20 and the rear substrate 22. In the illustrated example of FIG. 3, the front substrate 20 having the transparent conductive coating 28 (e.g., an ITO coating) may be welded to the rear substrate 22 having the metallic reflector coating 30 (e.g., an ISI coating or a CrRu coating) such that the ITO-coated glass may be welded to ISI-coated glass or CrRu-coated glass.

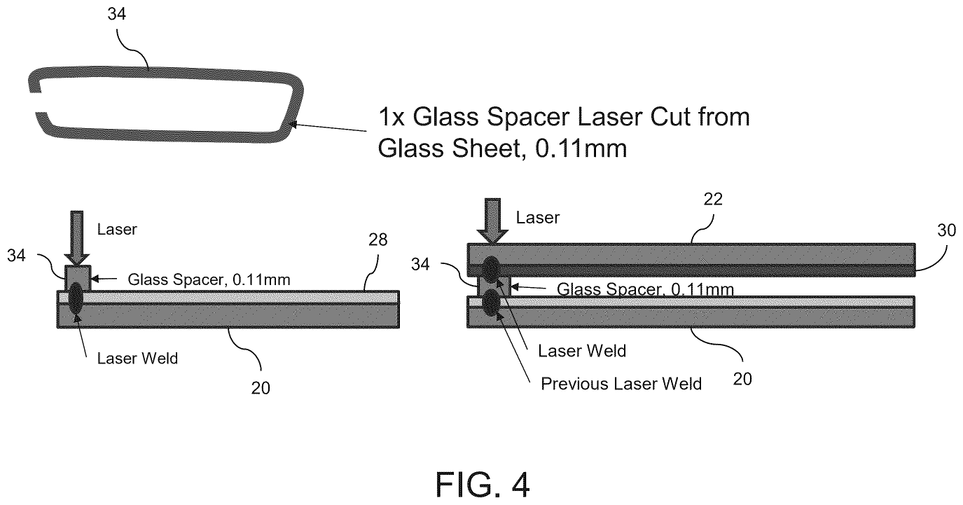

As shown in FIG. 4, the perimeter seal 26 may be formed with a glass spacer or precursor 34 disposed between the front substrate 20 and the rear substrate 22. For example, the glass spacer or precursor 34 may be laser cut from a glass sheet and have any suitable thickness, such as about 0.11 millimeters. During assembly of the mirror reflective element 16, the glass spacer 34 may be welded (e.g., laser welded) to the ITO-coated front glass substrate 20 at a perimeter edge region of the rear surface 20b of the front glass substrate 20 and then the ISI-coated or CrRu-coated rear glass substrate 22 may be welded (e.g., laser welded) to the glass spacer 34 at a perimeter edge region of the front surface 22a of the rear glass substrate 22 to form at least part of the perimeter seal 26 following welding. The glass spacer 34 may include a gap or opening, such that the glass spacer 34 does not completely circumscribe the mirror reflective element 16. In the illustrated example, the glass spacer 34 extends continuously between an upper perimeter edge region of the mirror reflective element 16, a lower perimeter edge region of the mirror reflective element 16, and one side perimeter edge region of the mirror reflective element 16, with the gap disposed at an opposing side perimeter edge region of the mirror reflective element 16. The electrochromic medium may be injected into the cavity between the front substrate 20 and the rear substrate 22 via the gap in the glass spacer 34 after the front substrate 20 and the rear substrate 22 are welded together via the glass spacer 34.

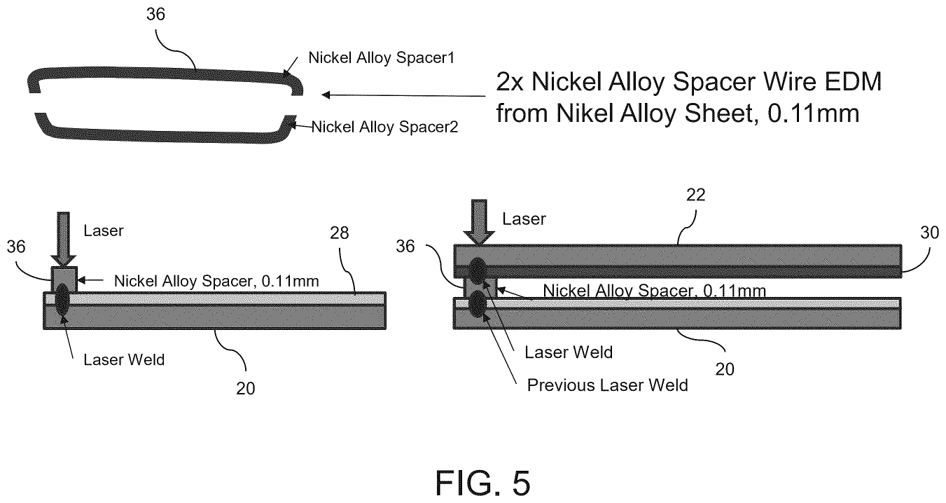

In some examples, the perimeter seal 26 may be formed with one or more metallic spacers or precursors 36 (e.g., nickel alloy spacers) between the front substrate 20 and the rear substrate 22 (FIG. 5). For example, a pair of metallic spacers or precursors 36 may be disposed at and welded (e.g., laser welded) to the ITO-coated front glass substrate 20 at the perimeter edge region of the rear surface 20b of the front glass substrate 20 and then the ISI-coated or CrRu-coated rear glass substrate 22 may be welded (e.g., laser welded) to the metallic spacers 36 at the perimeter edge region of the front surface 22a of the rear glass substrate 22 to form at least part of the perimeter seal 26 following welding. A first spacer may be disposed at an upper edge portion of the mirror reflective element 16 and a second spacer may be disposed at a lower edge portion of the mirror reflective element 16. The metallic spacers may include wires formed via electrical discharge machining (EDM) from a nickel alloy sheet, and may have any suitable thickness, such as about 0.11 millimeters. One or more gaps or openings may be disposed between opposing ends of the metallic spacers 36 so that the electrochromic medium may be injected into the cavity between the front substrate 20 and the rear substrate 22 via one or more of the gaps between the spacers 36 after the front substrate and the rear substrate are welded together via the metallic spacers 36. In the illustrated example, one metallic spacer 36 extends along the upper perimeter edge region of the mirror reflective element 16 and another metallic spacer extends along the lower perimeter edge region of the mirror reflective element 16, with the gaps disposed at opposing side perimeter edge regions of the mirror reflective element 16. The metallic spacers 36 may extend partially along the side perimeter edge regions of the mirror reflective element 16.

Thus, the front glass substrate 20 and the rear glass substrate 22 are joined together via laser welding that respectively joins the front glass substrate 20 to one or more spacers or precursors (e.g., glass spacers or metallic spacers) and joins the rear glass substrate 22 to the one or more spacers or precursors. The laser beam causes the spacer or precursor to bind and secure the front glass substrate 20 and the rear glass substrate 22 one to the other while maintaining the interpane spacing or gap between the front glass substrate 20 and the rear glass substrate 22 to be uniformly close to the thickness dimension of the spacer or precursor prior to the laser-welding via the laser beam of the spacer or precursor.

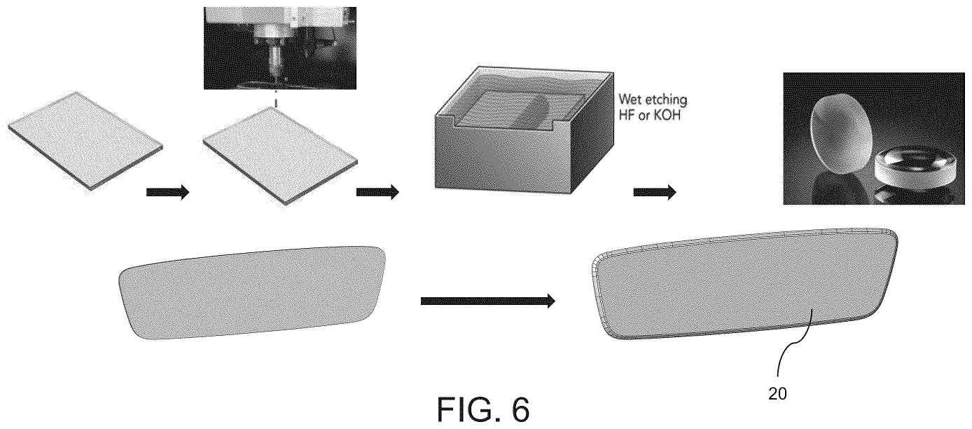

The mirror reflective element 16 may have a rounded or radiused edge or chamfered edge or other suitable transitional surface that extends at least partially between the first surface 20a of the front substrate 20 and the fourth surface 22b of the rear substrate 22 so that, with the mirror reflective element 16 received or attached at the mirror casing 14, the rounded edge may provide a smooth transition between the front of the mirror reflective element 16 and the side surface of the mirror casing 14. For example, and as shown in FIG. 6, laser machining may be used for processing the edge of the glass. That is, a laser ablation or laser machining process may remove material from an edge region of at least the front glass substrate 20 to create a chamfered or rounded or curved edge for the mirror reflective element. The edge may be processed prior to joining the front glass substrate 20 to the rear glass substrate 22 or after joining the two substrates together. The laser beam may move quickly over the front glass edge, removing glass material through vaporization or pulverization. The laser beam may be highly flexible or adaptable or reconfigurable, allowing for precise and complex machined shapes without any damage to the glass. In some examples, the laser beam may move quickly over the front glass edge, removing glass material through multiple straight cutting or through cleaving at multiple angles to approximate a contoured or rounded or curved profile. Optionally, during a selective laser etching (SLE) process after floating the glass substrate, the laser beam may move quickly over the front glass, modifying the glass material to a contoured or curved or rounded profile, with etching solution removing modified material from the front glass substrate 20. For example, the wet etching process may use hydrofluoric acid (HF) or potassium hydroxide (KOH). Edges of the glass substrates may be laser polished.

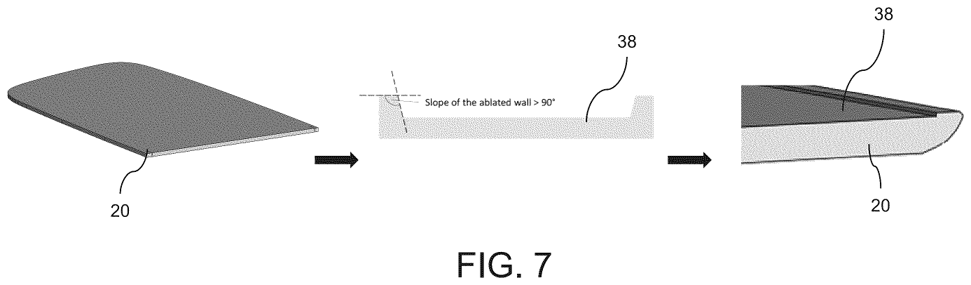

Optionally, and such as shown in FIG. 7, at least one of the front glass substrate 20 and the rear glass substrate 22 may be laser etched to form a recess or pocket or interpane cavity 38 between the front glass substrate and the rear glass substrate when joined together. The EC medium may then be injected into the pocket or recess. Because the EC medium may be at least partially recessed into one or both of the front substrate and the rear substrate, there may be little to no gap between the front substrate and the rear substrate and the mirror reflective element may be thinner. In the illustrated example, the recess 38 is formed at the second surface 20b of the front glass substrate 20. The front glass substrate 20 may be floated and a laser ablation process may form the cell gap. The front glass substrate 20 may then be laser polished. The recess 38 may include a substantially flat or planar surface recessed from the rear surface 20b of the front glass substrate 20 and a side wall circumscribing the recessed surface and extending between the recessed surface and the rear surface 20b. The wall may extend from the recessed surface at an angle of greater than 90 degrees.

The mirror reflective element having the laser etched rounded edges and recessed interpane cavity, with the front glass substrate and the rear glass substrate optionally joined together via a spacer laser welded to the front and rear glass substrates may utilize characteristics of the mirror assemblies described in U.S. provisional application Ser. No. 63/766,445, filed Mar. 4, 2025; U.S. provisional application Ser. No. 63/719,144, filed Nov. 12, 2024; U.S. provisional application Ser. No. 63/699,870, filed Sep. 27, 2024 and U.S. provisional application Ser. No. 63/641,076, filed May 1, 2024, all of which published as International Pat. Pub. No. WO 2025231091, and which all are hereby incorporated herein by reference in their entireties.

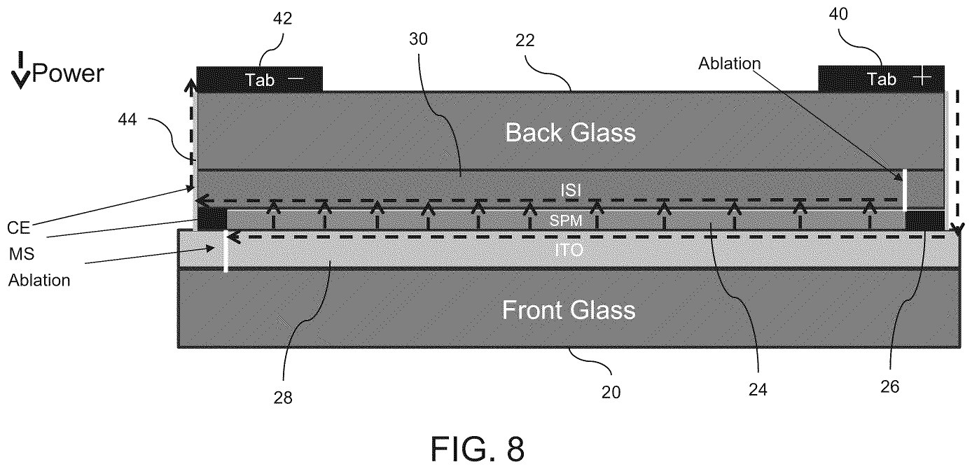

Referring to FIG. 8, electrical connection for electrically energizing the electrochromic medium 24 of the mirror reflective element 16 is provided at the rear surface 22b of the rear glass substrate 22. For example, a first electrical connector or tab 40 (e.g., a positive electrical connector) and a second electrical connector or tab 42 (e.g., a negative electrical connector) are disposed at the fourth surface 22b. The first tab 40 is in electrically connective connection with the transparent electrically conductive coating 28 at the rear surface 20b of the front glass substrate 20 and the second tab 42 is in electrically conductive connection with the metallic reflector coating 30 at the front surface 22a of the rear glass substrate 22. Thus, electrical current may flow from the first tab 40, across the transparent conductive coating 28, through the electrically conductive medium 24, across the metallic reflector coating 30 and to the second tab 42 to energize the electrochromic mirror reflective element 16. Ablation lines formed at the respective glass substrates may define the EC active area. As shown, electrical connection between the tabs 40, 42 and the electrically conductive layers may be provided outboard of the perimeter seal 26, such as via respective electrical connectors 44 (e.g., an electrically conductive epoxy, a thin wire, a wraparound tab, and the like) extending along a peripheral edge of the rear glass substrate 22 and the perimeter seal 26. The front glass substrate 20 may extend at least partially outboard of the rear glass substrate 22, with the electrical connectors 44 disposed at the peripheral edge of the rear glass substrate 22 and inboard of the peripheral edge of the front glass substrate 20.

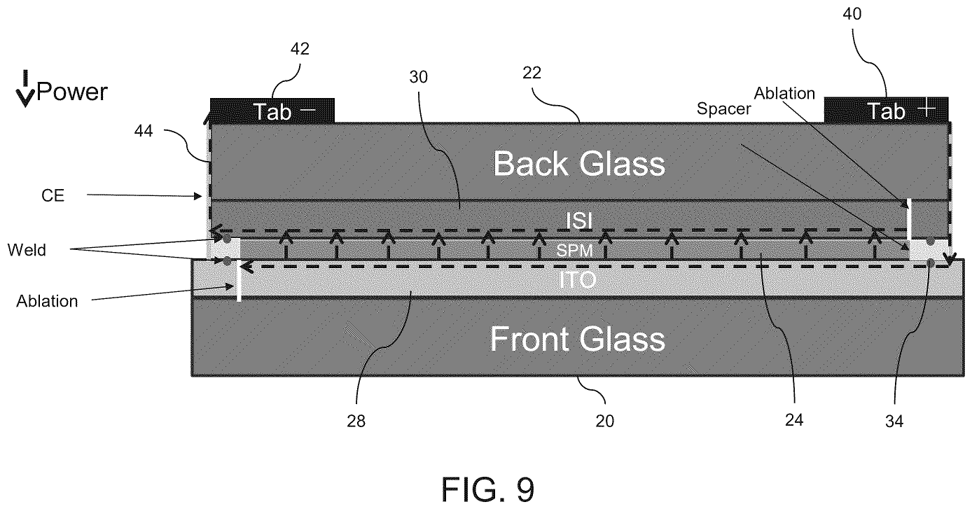

As shown in FIG. 9, when the glass spacer 34 is disposed between the front glass substrate 20 and the rear glass substrate 22, the glass spacer 34 is disposed outboard of the ablation lines at the front glass substrate 20 and the rear glass substrate 22. Thus, the glass spacer 34 may be laser welded to the coated surfaces of the respective substrates outboard of the EC active area. Electrically conductive epoxy 44 may extend along the outer or peripheral edge region of the rear glass substrate 22 and along an outer edge of the glass spacer 34 to electrically connect between the tabs 40, 42 and the conductive layers of the electrochromic mirror reflective element 16. Thus, with conductivity across the weld of the glass spacer 34, the electrification scheme may be kept with the main seal replaced with the glass spacer 34 and welding. Optionally, if there is no conductivity across the weld, a through glass via (TGV) or other electrification method may be utilized.

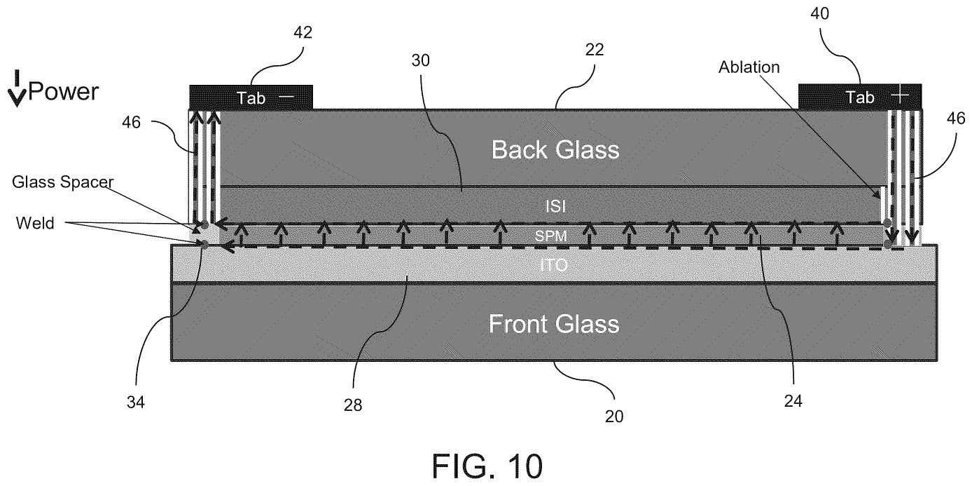

For example, and referring to FIG. 10, one or more TGVs 46 may be formed through the rear glass substrate 22 and/or the glass spacer 34 for electrically connecting the tabs 40, 42 to the transparent conductive coating 28 and the metallic reflector coating 30. Each TGV 46 includes a passageway or through hole extending from the fourth surface 22b of the rear glass substrate 22 to the third surface 22a of the rear glass substrate (and optionally through the glass spacer 34), with the passageway filled with an electrically conductive material such as a metallic conductor, for electrically connecting components at opposing ends of the TGV 46. One TGV or set of TGVs 46 extends through the rear glass substrate 22 and the glass spacer 34 to electrically connect the first tab 40 with the transparent conductive coating 28 at the rear surface 20b of the front glass substrate 20. Another TGV or set of TGVs 46 extends through the rear glass substrate 22 to electrically connect the second tab 42 with the metallic reflector coating 30 at the front surface 22a of the rear glass substrate 22. That is, one set of vias 46 travel from the fourth surface 22b through the rear glass substate 22 and the glass spacer 34 to contact the second surface 20b and another sent of vias 46 travel from the fourth surface 22b to the third surface 22a. The TGVs 46 may be fully metalized (i.e., filled with copper or the like) to survive environmental durability testing such as autoclave. Moreover, the TGVs 46 may be disposed at the perimeter edge region of the rear glass substrate 22 and outboard of the ablation lines and aligned with the tabs 40, 42 and the glass spacer 34 or perimeter seal to be disposed outboard of the EC active area and so that the TGVs 46, tabs 40, 42, and/or glass spacer 34 or perimeter seal may be hidden by a hiding layer or film disposed at the mirror reflective element 16.

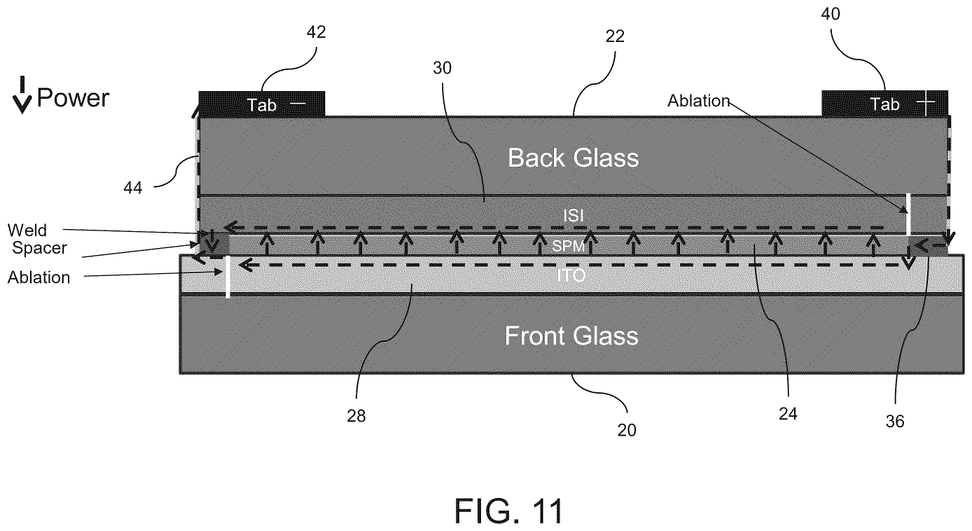

Optionally, the metallic spacer 36 may electrically connect between the tabs 40, 42 and the transparent conductive coating 28 and/or the metallic reflector coating 30 (FIG. 11). In the illustrated example, electrically conductive epoxy 44 extends along the perimeter edge of the rear glass substrate 22 to electrically connect between the tabs 40, 42 and the metallic spacer 36 that is disposed between the front glass substrate 20 and the rear glass substrate 22 and that engages the transparent conductive coating 28 and the metallic reflector coating 30. An ablation line formed through the metallic reflector coating 30 may electrically isolate one portion of the metallic spacer 36 electrically connected to the first tab 40 from the metallic reflector coating 30. Another ablation line formed through the transparent conductive coating 28 may electrically isolate another portion of the metallic spacer 36 electrically connected to the second tab 42 from the transparent conductive coating 28. Thus, electrical current may flow from the first tab 40, through the conductive epoxy 44 and metallic spacer 36, across the transparent conductive coating 28 and through the electrochromic medium 24, across the metallic reflector coating 30 and through the metallic spacer 36 and conductive epoxy 44 to the second tab 42 to energize the electrochromic mirror reflective element 16.

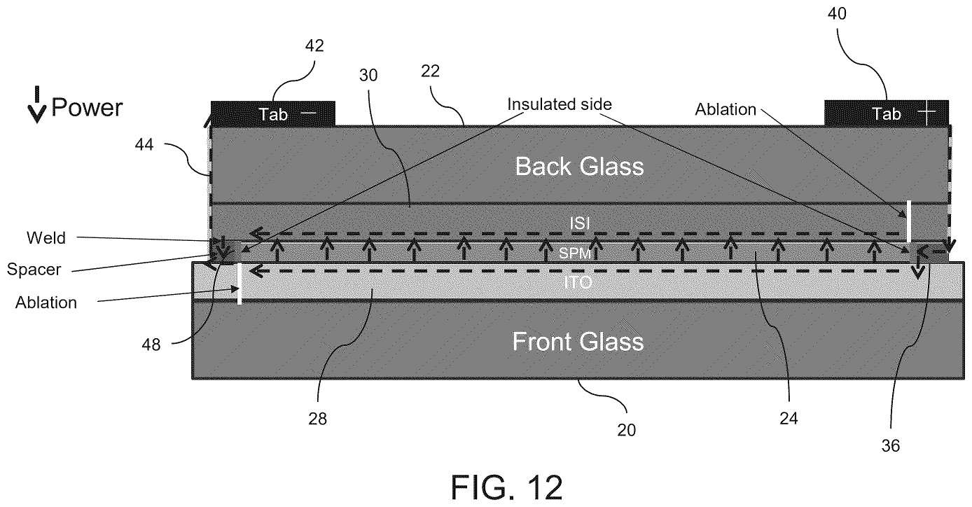

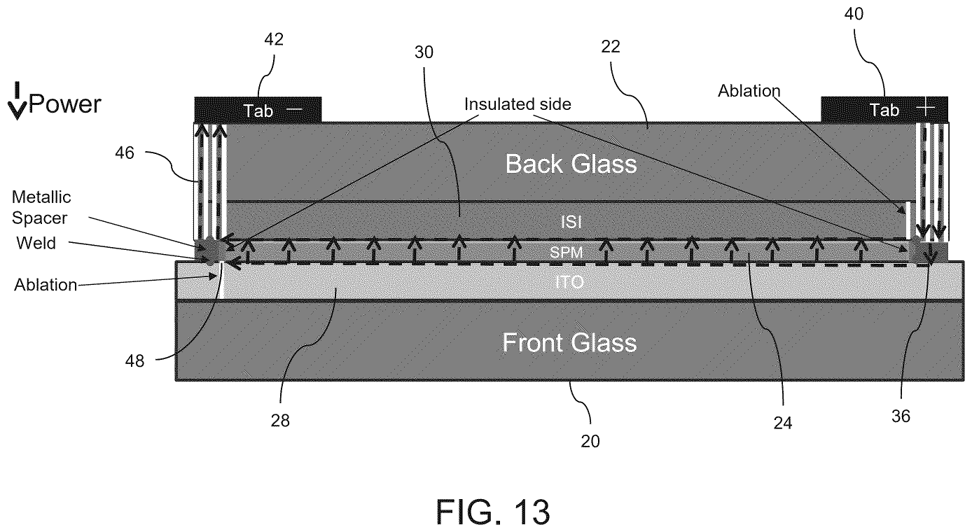

The metallic spacer 36 may be insulated from the electrochromic medium 24 so that current only flows from the first tab 40 to the spacer 36 to the transparent electrically conductive coating 28 to the electrochromic medium 24 (FIGS. 12 and 13). For example, an insulation layer or material 48 may be disposed inboard of the metallic spacer 36 between the electrochromic medium 24 and the metallic spacer 36. Thus, with the metallic spacer 36 welded to the rear glass substrate 22 coated with the metallic reflector 30 and the front glass substrate 20 coated with the transparent conductive coating 28, power from the first tab 40 is forced to travel through the spacer 36, charge the transparent conductive coating 28, travel through the electrochromic medium 24, charge the metallic reflector coating 30, and travel through the other portion of the metallic spacer 36 to the second tab 42. The first tab 40 and the second tab 42 may be electrically connected to the insulated metallic spacer 36 via conductive epoxy 44 or other conductive material extending along the peripheral edge of the rear glass substrate 22 (FIG. 12). Optionally, the first tab 40 and the second tab 42 may be electrically connected to the insulated metallic spacer 36 through one or more TGVs 46 extending through the rear glass substrate 22 (FIG. 13).

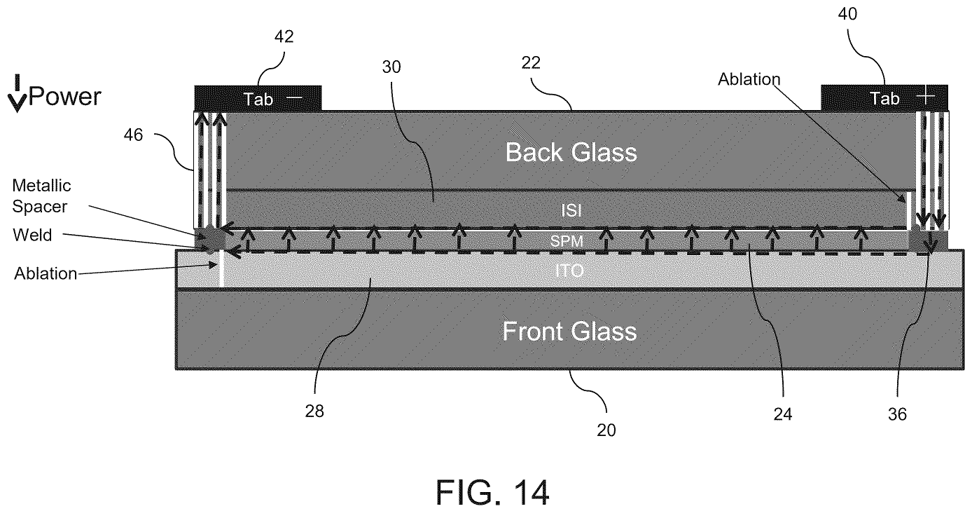

Optionally, the metallic spacer 36 may not be insulated and the metallic spacer 36 may electrically connect to the tabs 40, 42 via one or more TGVs 46 formed through the rear glass substrate 22 (FIG. 14). Because the metallic spacer 36 is not insulated from the electrochromic medium 24, the metallic spacer 36 may be less resistive than the transparent conductive coating 28 and more resistive than the metallic reflector 30 to charge both the second surface 20b and the third surface 22a of the mirror reflective element 16 before completing the circuit.

Thus, the mirror reflective element 16 may include a spacer or precursor, such as a non-conductive glass or epoxy spacer or a conductive metallic spacer, disposed between the front glass substrate 20 and the rear glass substrate 22. The spacer may provide a uniform cell gap between the glass substrates and the glass substrates may be welded to the spacer during the assembly process to form at least part of the perimeter seal of the electrochromic cell. Electrification of the transparent conductive coating 28 and the metallic reflector coating 30 may be accomplished via conductors (e.g., a conductive epoxy) extending between the fourth surface 22b and the third surface 22a along the outer peripheral edge of the rear glass substrate 22 or via TGVs 46 formed through the rear glass substrate 22. The glass spacer 34 may insulate the electrochromic medium 24 from the electrical conductors such that the conductors may extend along the outer edge of the glass spacer 34 or the TGVs 46 may extend through the glass spacer 34 to connect to the metallic reflector coating 30. An insulating layer or coating may be disposed between the metallic spacer 36 and the electrochromic medium 24 or the metallic spacer 36 may have a lower resistance than the transparent conductive coating 28 and a greater resistance than the metallic reflector coating 30.

Thus, in the illustrated example, the front interior mirror shaped glass substrate 20 (coated on its second surface 20b by a transparent conductive coating such as ITO), is spaced apart from the rear glass substrate 22 (coated on its third surface 22a with an electrically conductive layer or layers, such as the metallic mirror reflector 30 comprising a silver or silver gold alloy metal thin film or a mirror transflector comprising a multilayer stack of non-metallic dielectric metal oxide coatings such as described in International Patent Publication No. WO 2022187805, which is incorporated herein by reference in its entirety) by at least one of a laser-welded metal or a glass perimeter spacer or precursor. The metal and/or glass precursor spaces the front substrate 20 and the rear substrate 22 and forms at least part of the perimeter seal 26 following welding of the spacer to the front substrate 20 and the rear substrate 22. The thickness of the perimeter spacer may be greater than 20 microns and less than 250 microns; greater than 50 microns and less than 200 microns; greater than 75 microns and less than 125 microns, and the like. The width of the perimeter spacer may be greater than 0.5 millimeters and less than 4 millimeters; greater than 0.75 millimeters and less than 3 millimeters; greater than 1 millimeter and less than 1.5 millimeter, and the like. The shape and dimension of the rear substrate 22 may correspond to the shape and dimension of the front substrate 22 such that when juxtaposed, the perimeter edges of the front substrate 20 and the rear substrate 22 are flush with one another. Optionally, the perimeter edge of the rear substrate 22 is disposed inward or inboard of the perimeter edge of the front substrate by no more than about 2 millimeters, no more than about 1.5 millimeters, no more than about 1 millimeter, and the like.

With the front substrate 20 and the rear substrate 22 assembled with the spacer or precursor disposed therebetween (and optionally already laser welded to one of the substrates), a laser is used to laser weld the spacer or precursor to the substrates to form at least part of the perimeter seal. Optionally, a small gap is present between portions of the spacer to allow for filling of the electrochromic medium injected through the gap. The gap may then be filled with epoxy to seal the cell. Optionally, a fill hole may be formed through one of the front glass substrate and the rear glass substrate such that the perimeter seal fully circumscribes the mirror reflective element and there is no gap in the perimeter seal. Thus, the electrochromic medium may be injected into the interpane cavity via the fill hole through the glass substrate. Alternatively, a metered and measured amount of electrochromic medium may be metered onto one of the front substrate and the rear substrate inboard of the spacer and when the other substrate is juxtaposed with the space between the substrates, the metered amount of material fully fills the interpane cavity without leaving bubbles or gaps. Thus, no fill hole is needed in either the perimeter seal or one of the substrates and the electrochromic medium may be disposed between the glass substrates before the glass substrates are welded to one another and the spacer to form the perimeter seal. Laser welding of the spacer or precursor forms a hermetic perimeter seal that bounds and contains the electrochromic medium between the spaced-apart front and rear substrates. The laser-welded spacer or precursor forms an airtight (and moisture tight) barrier that prevents gases (such as oxygen), liquids or contaminants passing through the perimeter seal to enter into the electrochromic medium. Furthermore, the laser-welded spacer or precursor may be used for electrically-dimmable electro-optic mirror elements other than electrochromic mirror elements (for example, liquid crystal mirror elements).

The mirror assembly may comprise any suitable construction, such as, for example, a mirror assembly with the reflective element being nested in the mirror casing and with a bezel portion that circumscribes a perimeter region of the front surface of the reflective element, or with the mirror casing having a curved or beveled outermost exposed perimeter edge around the reflective element and with no overlap onto the front surface of the reflective element (such as by utilizing aspects of the mirror assemblies described in U.S. Pat. Nos. 7,184,190; 7,274,501; 7,255,451; 7,289,037; 7,360,932; 7,626,749; 8,049,640; 8,277,059 and/or 8,529,108, which are hereby incorporated herein by reference in their entireties) or such as a mirror assembly having a rear substrate of an electro-optic or electrochromic reflective element nested in the mirror casing, and with the front substrate having a curved or beveled outermost exposed perimeter edge, or such as a mirror assembly having a prismatic reflective element that is disposed at an outer perimeter edge of the mirror casing and with the prismatic substrate having a curved or beveled outermost exposed perimeter edge, such as described in U.S. Pat. Nos. 9,827,913; 9,174,578; 8,508,831; 8,730,553; 9,598,016 and/or 9,346,403, and/or U.S. Des. Pat. Nos. D633,423; D633,019; D638,761 and/or D647,017, which are hereby incorporated herein by reference in their entireties (and with electrochromic and prismatic mirrors of such construction are commercially available from the assignee of this application under the trade name INFINITY™ mirror).

As discussed above, the mirror assembly may comprise an electro-optic or electrochromic mirror assembly that includes an electro-optic or electrochromic variably reflective mirror reflective element. The perimeter edges of the reflective element may be encased or encompassed by the perimeter element or portion of the bezel portion to conceal and contain and envelop the perimeter edges of the substrates and the perimeter seal disposed therebetween. The variably reflective mirror reflective element of the mirror assembly may utilize aspects of the mirror reflective elements described in commonly assigned U.S. Pat. Nos. 7,626,749; 7,274,501; 7,255,451; 7,195,381; 7,184,190; 6,690,268; 5,140,455; 5,151,816; 6,178,034; 6,154,306; 6,002,544; 5,567,360; 5,525,264; 5,610,756; 5,406,414; 5,253,109; 5,076,673; 5,073,012; 5,115,346; 5,724,187; 5,668,663; 5,910,854; 5,142,407 and/or 4,712,879, and/or U.S. Publication No. U.S.-2022-0371513, which are hereby incorporated herein by reference in their entireties.

Optionally, the reflective element may include an opaque or substantially opaque or hiding perimeter layer or coating or band disposed around a perimeter edge region of the front substrate (such as at a perimeter region of the rear or second surface of the front substrate) to conceal or hide or the perimeter seal from viewing by the driver of the vehicle when the mirror assembly is normally mounted in the vehicle. Such a hiding layer or perimeter band may be reflective or not reflective and may utilize aspects of the perimeter bands and mirror assemblies described in U.S. Pat. Nos. 5,066,112; 7,626,749; 7,274,501; 7,184,190; 7,255,451; 8,508,831 and/or 8,730,553, which are all hereby incorporated herein by reference in their entireties. Optionally, the perimeter band may comprise a chrome/chromium coating or metallic coating and/or may comprise a chrome/chromium or metallic coating that has a reduced reflectance, such as by using an oxidized chrome coating or chromium oxide coating or “black chrome” coating or the like (such as by utilizing aspects of the mirror assemblies described in U.S. Pat. No. 7,184,190 and/or 7,255,451, which are hereby incorporated herein by reference in their entireties). Optionally, other opaque or substantially opaque coatings or bands may be implemented.

Although shown and described as a mirror reflective element for an interior rearview mirror assembly that mounts at an interior portion of the vehicle (e.g., at a windshield or headliner of a vehicle equipped with the mirror assembly) via mounting structure, the mirror reflective element is suitable for use in an exterior rearview mirror assembly. For example, the exterior rearview mirror assembly may include a mounting arm having an attaching end that attaches at an exterior portion of the vehicle and a distal end distal from the attaching end. A mirror head is disposed at the distal end of the mounting arm and accommodates the electrochromic mirror reflective element, whereby the mirror reflective element is adjustable to set a rearward view of the driver along the side of the vehicle. Optionally, the mirror reflective element may adjust together and in tandem with the mirror head so that the mirror head may be positionable or adjustable relative to a side of the vehicle to set the rearward view of the driver along the side of the vehicle.

The mirror assembly may utilize aspects of the mirror assemblies described in U.S. Publication Nos. US-2021-0331625; US-2021-0316664; US-2021-0213880; US-2020-0353867 and/or US-2020-0223364, and/or U.S. Pat. Nos. 11,325,535; 10,099,618; 9,827,913; 9,487,142; 9,346,403 and/or 8,915,601, which are all hereby incorporated herein by reference in their entireties.

Changes and modifications in the specifically described embodiments may be carried out without departing from the principles of the present invention, which is intended to be limited only by the scope of the appended claims as interpreted according to the principles of patent law.

1. A vehicular interior electrochromic rearview mirror assembly, the vehicular interior electrochromic rearview mirror assembly comprising:
a mirror head adjustable relative to a mounting base, wherein the mounting base is configured to mount the vehicular interior electrochromic rearview mirror assembly at an interior portion of an interior cabin of a vehicle;
wherein the mirror head accommodates an electrochromic mirror reflective element;
wherein, with the vehicular interior electrochromic rearview mirror assembly mounted at the interior portion of the interior cabin of the vehicle, the mirror head is adjustable by a driver of the vehicle to set a rearward view for the driver;
wherein the electrochromic mirror reflective element comprises (i) a front glass substrate having a first side and a second side separated from the first side by a thickness of the front glass substrate and (ii) a rear glass substrate having a third side and a fourth side separated from the third side by a thickness of the rear glass substrate;
wherein the front glass substrate has an outer peripheral edge that spans between the first side and the second side;
wherein the rear glass substrate has an outer peripheral edge that spans between the third side and the fourth side;
wherein the electrochromic mirror reflective element comprises an electrochromic medium disposed in an interpane cavity of the electrochromic mirror reflective element between the second side of the front glass substrate and the third side of the rear glass substrate;
wherein the front glass substrate is joined with the rear glass substrate via a perimeter seal that bounds the electrochromic medium disposed in the interpane cavity;
wherein the perimeter seal comprises at least one selected from the group consisting of (i) a laser-welded glass spacer disposed between the front glass substrate and the rear glass substrate and spacing the front glass substrate and the rear glass substrate and (ii) a laser-welded metallic spacer disposed between the front glass substrate and the rear glass substrate and spacing the front glass substrate and the rear glass substrate;
wherein a transparent electrically conductive coating is disposed at the second side of the front glass substrate and contacts the electrochromic medium;
wherein an electrically conductive coating is disposed at the third side of the rear glass substrate;
wherein the electrochromic medium is in electrically conductive contact with the transparent electrically conductive coating disposed at the second side of the front glass substrate and with the electrically conductive coating disposed at the third side of the rear glass substrate;
wherein the transparent electrically conductive coating is electrically connected to a first electrical connector; and
wherein the electrically conductive coating is electrically connected to a second electrical connector.

2. The vehicular interior electrochromic rearview mirror assembly of claim 1, wherein the perimeter seal comprises the laser-welded glass spacer disposed between the front glass substrate and the rear glass substrate, and wherein the front glass substrate and the rear glass substrate are each laser welded to the glass spacer, and wherein the glass spacer is formed from a glass sheet.

3. The vehicular interior electrochromic rearview mirror assembly of claim 1, wherein a first electrically conductive element electrically connects the transparent electrically conductive coating to the first electrical connector, and wherein a second electrically conductive element electrically connects the electrically conductive coating to the second electrical connector.

4. The vehicular interior electrochromic rearview mirror assembly of claim 3, wherein the first electrically conductive element is disposed at the outer peripheral edge of the rear glass substrate and an outboard portion of the perimeter seal, and wherein the second electrically conductive element is disposed at the outer peripheral edge of the rear glass substrate.

5. The vehicular interior electrochromic rearview mirror assembly of claim 4, wherein the first electrically conductive element and the second electrically conductive element both comprise an electrically conductive epoxy.

6. The vehicular interior electrochromic rearview mirror assembly of claim 3, wherein the first electrically conductive element is disposed within a first through glass via (TGV) formed through the rear glass substrate, and wherein the second electrically conductive element is disposed within a second TGV formed through the rear glass substrate.

7. The vehicular interior electrochromic rearview mirror assembly of claim 6, wherein the perimeter seal comprises the laser-welded glass spacer disposed between the front glass substrate and the rear glass substrate, and wherein the first TGV is formed through the rear glass substrate and the laser-welded glass spacer, and wherein the first electrically conductive element extends within the first TGV and between the first electrical connector and the transparent electrically conductive coating to electrically connect the transparent electrically conductive coating to the first electrical connector, and wherein the second electrically conductive element extends within the second TGV and between the second electrical connector and the electrically conductive coating to electrically connect the electrically conductive coating to the second electrical connector.

8. The vehicular interior electrochromic rearview mirror assembly of claim 6, wherein the perimeter seal comprises the laser-welded metallic spacer disposed between the front glass substrate and the rear glass substrate, and wherein the laser-welded metallic spacer is in electrically conductive contact with the transparent electrically conductive coating, and wherein the first electrically conductive element extends within the first TGV and between the first electrical connector and the laser-welded metallic spacer to electrically connect the transparent electrically conductive coating to the first electrical connector, and wherein the second electrically conductive element extends within the second TGV and between the second electrical connector and the electrically conductive coating to electrically connect the electrically conductive coating to the second electrical connector.

9. The vehicular interior electrochromic rearview mirror assembly of claim 8, wherein the laser-welded metallic spacer is electrically insulated from the electrochromic medium.

10. The vehicular interior electrochromic rearview mirror assembly of claim 8, wherein the laser-welded metallic spacer is in electrically conductive contact with the electrochromic medium.

11. The vehicular interior electrochromic rearview mirror assembly of claim 10, wherein a resistance of the laser-welded metallic spacer (i) is less than a resistance of the transparent electrically conductive coating and (i) is greater than a resistance of the electrically conductive coating.

12. The vehicular interior electrochromic rearview mirror assembly of claim 1, wherein the first electrical connector and the second electrical connector are disposed at the fourth side of the rear glass substrate.

13. A vehicular interior electrochromic rearview mirror assembly, the vehicular interior electrochromic rearview mirror assembly comprising:
a mirror head adjustable relative to a mounting base, wherein the mounting base is configured to mount the vehicular interior electrochromic rearview mirror assembly at an interior portion of an interior cabin of a vehicle;
wherein the mirror head accommodates an electrochromic mirror reflective element;
wherein, with the vehicular interior electrochromic rearview mirror assembly mounted at the interior portion of the interior cabin of the vehicle, the mirror head is adjustable by a driver of the vehicle to set a rearward view for the driver;
wherein the electrochromic mirror reflective element comprises (i) a front glass substrate having a first side and a second side separated from the first side by a thickness of the front glass substrate and (ii) a rear glass substrate having a third side and a fourth side separated from the third side by a thickness of the rear glass substrate;
wherein the front glass substrate has an outer peripheral edge that spans between the first side and the second side;
wherein the rear glass substrate has an outer peripheral edge that spans between the third side and the fourth side;
wherein the electrochromic mirror reflective element comprises an electrochromic medium disposed in an interpane cavity of the electrochromic mirror reflective element between the second side of the front glass substrate and the third side of the rear glass substrate;
wherein the front glass substrate is joined with the rear glass substrate via a perimeter seal that bounds the electrochromic medium disposed in the interpane cavity;
wherein the perimeter seal comprises a laser-welded glass spacer disposed between the front glass substrate and the rear glass substrate and spacing the front glass substrate and the rear glass substrate;
wherein the front glass substrate is laser welded to the glass spacer, and wherein the rear glass substrate is laser welded to the glass spacer;
wherein a transparent electrically conductive coating is disposed at the second side of the front glass substrate and contacts the electrochromic medium;
wherein an electrically conductive coating is disposed at the third side of the rear glass substrate;
wherein the electrochromic medium is in electrically conductive contact with the transparent electrically conductive coating disposed at the second side of the front glass substrate and with the electrically conductive coating disposed at the third side of the rear glass substrate;
wherein the transparent electrically conductive coating is electrically connected to a first electrical connector;
wherein the electrically conductive coating is electrically connected to a second electrical connector;
wherein a first electrically conductive element electrically connects the transparent electrically conductive coating to the first electrical connector, and wherein a second electrically conductive element electrically connects the electrically conductive coating to the second electrical connector; and
wherein the first electrically conductive element is disposed within a first through glass via (TGV) formed through the rear glass substrate and the laser-welded glass spacer, and wherein the second electrically conductive element is disposed within a second TGV formed through the rear glass substrate.

14. The vehicular interior electrochromic rearview mirror assembly of claim 13, wherein the glass spacer is formed from a glass sheet.

15. The vehicular interior electrochromic rearview mirror assembly of claim 13, wherein the first electrically conductive element extends within the first TGV and between the first electrical connector and the transparent electrically conductive coating to electrically connect the transparent electrically conductive coating to the first electrical connector, and wherein the second electrically conductive element extends within the second TGV and between the second electrical connector and the electrically conductive coating to electrically connect the electrically conductive coating to the second electrical connector.

16. The vehicular interior electrochromic rearview mirror assembly of claim 13, wherein the first electrical connector and the second electrical connector are disposed at the fourth side of the rear glass substrate.

17. A vehicular interior electrochromic rearview mirror assembly, the vehicular interior electrochromic rearview mirror assembly comprising:
a mirror head adjustable relative to a mounting base, wherein the mounting base is configured to mount the vehicular interior electrochromic rearview mirror assembly at an interior portion of an interior cabin of a vehicle;
wherein the mirror head accommodates an electrochromic mirror reflective element;
wherein, with the vehicular interior electrochromic rearview mirror assembly mounted at the interior portion of the interior cabin of the vehicle, the mirror head is adjustable by a driver of the vehicle to set a rearward view for the driver;
wherein the electrochromic mirror reflective element comprises (i) a front glass substrate having a first side and a second side separated from the first side by a thickness of the front glass substrate and (ii) a rear glass substrate having a third side and a fourth side separated from the third side by a thickness of the rear glass substrate;
wherein the front glass substrate has an outer peripheral edge that spans between the first side and the second side;
wherein the rear glass substrate has an outer peripheral edge that spans between the third side and the fourth side;
wherein the electrochromic mirror reflective element comprises an electrochromic medium disposed in an interpane cavity of the electrochromic mirror reflective element between the second side of the front glass substrate and the third side of the rear glass substrate;
wherein the front glass substrate is joined with the rear glass substrate via a perimeter seal that bounds the electrochromic medium disposed in the interpane cavity;
wherein the perimeter seal comprises a laser-welded metallic spacer disposed between the front glass substrate and the rear glass substrate and spacing the front glass substrate and the rear glass substrate;
wherein the front glass substrate is laser welded to the metallic spacer, and wherein the rear glass substrate is laser welded to the metallic spacer;
wherein the laser-welded metallic spacer is in electrically conductive contact with the electrochromic medium;
wherein a transparent electrically conductive coating is disposed at the second side of the front glass substrate and contacts the electrochromic medium;
wherein an electrically conductive coating is disposed at the third side of the rear glass substrate;
wherein the electrochromic medium is in electrically conductive contact with the transparent electrically conductive coating disposed at the second side of the front glass substrate and with the electrically conductive coating disposed at the third side of the rear glass substrate;
wherein the transparent electrically conductive coating is electrically connected to a first electrical connector;
wherein the electrically conductive coating is electrically connected to a second electrical connector; and
wherein a first electrically conductive element electrically connects the transparent electrically conductive coating to the first electrical connector, and wherein a second electrically conductive element electrically connects the electrically conductive coating to the second electrical connector.

18. The vehicular interior electrochromic rearview mirror assembly of claim 17, wherein the first electrically conductive element is disposed at the outer peripheral edge of the rear glass substrate and an outboard portion of the perimeter seal, and wherein the second electrically conductive element is disposed at the outer peripheral edge of the rear glass substrate, and wherein the first electrically conductive element and the second electrically conductive element both comprise an electrically conductive epoxy.

19. The vehicular interior electrochromic rearview mirror assembly of claim 17, wherein the first electrically conductive element is disposed within a first through glass via (TGV) formed through the rear glass substrate, and wherein the second electrically conductive element is disposed within a second TGV formed through the rear glass substrate, and wherein the laser-welded metallic spacer is in electrically conductive contact with the transparent electrically conductive coating, and wherein the first electrically conductive element extends within the first TGV and between the first electrical connector and the laser-welded metallic spacer to electrically connect the transparent electrically conductive coating to the first electrical connector, and wherein the second electrically conductive element extends within the second TGV and between the second electrical connector and the electrically conductive coating to electrically connect the electrically conductive coating to the second electrical connector.

20. The vehicular interior electrochromic rearview mirror assembly of claim 17, wherein a resistance of the laser-welded metallic spacer (i) is less than a resistance of the transparent electrically conductive coating and (i) is greater than a resistance of the electrically conductive coating.
